(19) United States
(12) Patent Application Publication
(10) Pub. No.: US 2003/0170096 A1
(43) Pub. Date: Sep. 11, 2003

(54) Air activation for a vehicle restraint

(76) Inventor: James C. Alexander, London (CA)

Correspondence Address: BAKER + HOSTETLER LLP, WASHINGTON SQUARE, SUITE 1100, 1050 CONNECTICUT AVE. N.W., WASHINGTON, DC, 20036-5304, US

(21) Appl. No.: 10/093,472

(22) Filed: Mar. 11, 2002

(51) Int. Cl. B65G 69/00

(52) U.S. Cl. 414/401; 414/396; 414/584

(57) ABSTRACT

A method and apparatus for actuating a vehicle restraint device, particularly suited for a loading dock to prevent a transport vehicle from inadvertently moving away from the dock, use air activation.

### FIELD OF THE INVENTION

This invention is an improved method and apparatus for actuating a vehicle restraint that is typically used at a loading dock to prevent a transport vehicle from inadvertently moving away from the dock. A typical vehicle restraint has a hook or restraining member that travels vertically to engage the rear impact guard (RIG, also known as ICC bar) of a transport vehicle. The restraining member is typically stored in a lowered position and is raised to engage the RIG. Because the suspension of the transport vehicle will deflect under changing loads, the restraining member must have the ability to “float” or move vertically with the vehicle as the suspension deflects under varying load.

### BACKGROUND OF THE INVENTION

Many different methods have been used to activate engagement and provide float for a vehicle restraint. Some have used compressed air in a cylinder to provide both activation and float. The device shown in U.S. Pat. No. 4,555,211 uses high pressure air to extend a cylinder and thus engagen the restraining member. Because compressed air contains moisture, such devices are not practical in cold weather as the moisture will freeze in the lines and valves. Also the rotating hook with fixed pivot location is not well suited to restraining trucks of various height.

Most prior art vehicle restraining devices have a restraining member that remains horizontal and moves vertically to engage the RIG of the transport vehicle. Because the retracted length of a typical actuator or cylinder is greater than the stroke or travel distance, many complex devices have been designed to provide a vehicle restraint with vertical travel of the restraining member greater than the stored height. The devices shown in U.S. Pat. Nos. 4,759,678 and 5,212,846 use a long cylinder to raise the restraining member but the long stroke requires that the cylinder be placed in a hole in the ground, making installation more difficult and expensive. The devices shown in U.S. Pat. Nos. 4,815,918 and 6,113,337 use chain and sprockets to move the restraining member twice the distance of the actuator stroke. U.S. Pat. No. 4,767,254 uses two sets of actuators and an intermediate carriage to provide travel equal to the sum of the travel of the two actuators. U.S. Pat. Nos. 4,861,217 and 5,120,181 use rotating arms to multiply the travel distance of the actuator. Other methods are a rack and pinion shown in U.S. Pat. No. 4,488,325 and a cable and drum shown in U.S. Pat. No. 6,106, 212.

Most prior art devices use one means to engage the restraining member and a second means to provide float to follow the vertical motion of the transport vehicle. The devices shown in U.S. Pat. Nos. 4,488,325 and 6,106,212 use mechanical springs for float. Such springs have limited float and may not be able to follow the full range of motion of transport vehicles with soft suspensions. Other devices such as those shown in U.S. Pat. Nos. 4,861,217 and 5,120,181 use gas springs to upwardly bias the restraining member and mechanical or hydraulic actuating devices to overcome the force of the springs and lower the restraining member to the stored position.

### SUMMARY OF INVENTION

This invention is a simplified actuating method for lifting the restraining member of a vehicle restraint and providing upward bias to follow the vertical motion of transport vehicle. A flexible body inflated by low pressure gas lifts the restraining member and provides upward bias. Thus the inflatable flexible body replaces both the actuating device and the float springs of conventional upward biased vehicle restraints. Because the flexible body has very low collapsed height the vehicle restraint can have a low stored height combined with high travel distance. The inflating means is preferably a blower that can be mounted on the base of the restraint device or can be mounted remotely and connected by a duct. The inflatable flexible body can be adapted to many different configurations of vehicle restraint.

There has been outlined, rather broadly, the more important features of the invention in order that the detailed description thereof that follows may be better understood, and in order that the present contribution to the art may be better appreciated. There are, of course, additional features of the invention that will be described below and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein, as well as the abstract, are for the purposes of description and should not be regarded as limiting.

As such, those skilled in the art will appreciate that the conception upon which this disclosure is based may readily be utilized as a basis for the designing of other structures, methods and systems for carrying out the several purposes of the present invention. It is important, therefore, that the claims be regarded as including such equivalent construction insofar as they do not depart from the spirit and scope of the present invention.

### BRIEF DESCRIPTION OF THE DRAWING

FIG. 1 is a perspective view of a vehicle restraint having a restraining hook carried by a pivoting arm and guided by an arcuate track mounted to the dock wall, with the restraint in the stored position.

FIG. 2 is the restraint of FIG. 1 in the operative position with the restraining hook raised by an inflatable flexible body to engage the RIG of a transport vehicle.

FIG. 3 is a perspective view of a vehicle restraint having a restraining hook vertically guided by a track mounted to the dock wall, with the restraint in the stored position.

FIG. 4 is a perspective view of the restraint of FIG. 3 in the operative position with the restraining hook raised by an inflatable flexible body to engage the RIG of a transport vehicle.

FIG. 5 is a perspective view of the hook assembly of the device in FIGS. 3 & 4 showing the guide rollers.

FIG. 6 is a sectional side view of a vehicle restraint having a restraining hook carried by a mechanism with pivoting bars to guide the vertical travel, and raised by an inflatable flexible body, with the restraint in the stored position.

FIG. 7 is a sectional side view of the restraint of FIG. 6 in the operative position with the restraining hook raised by an inflatable flexible body to engage the RIG of a transport vehicle.

FIG. 8 is a front view of the restraint of FIG. 7.

FIG. 9 is a side view of a vehicle restraint similar to that of FIG. 6 however, having two lateral inflatable flexible bodies to raise the restraining hook.

FIG. 10 is a front view of the restraint of FIG. 9.

FIG. 11 is a side view of a vehicle restraint similar to that of FIG. 6 however, having a lift mechanism environmentally sealed within an inflatable flexible body to raise the restraining hook member.

FIG. 12 is a front view of the restraint of FIG. 11.

### DETAILED DESCRIPTION OF PREFERRED EMBODIMENTS OF THE INVENTION

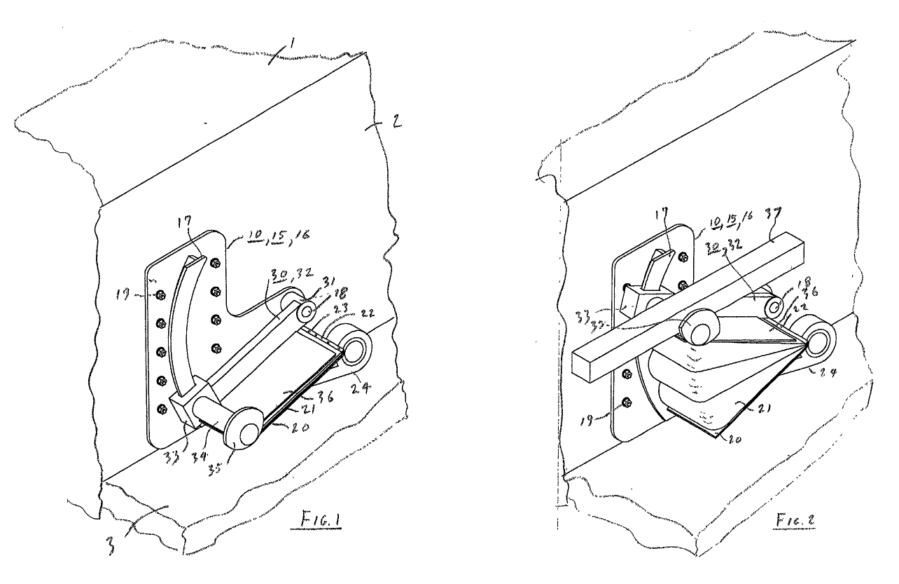

Referring now to FIGS. 1 and 2 a first preferred embodiment is illustrated. A loading dock has a dock floor 1, a dock wall 2 and a driveway 3. A vehicle restraint 10 is mounted on the dock wall 2. The vehicle restraint 10 has a supporting frame assembly 15 composed of a plate 16, a “T” shaped arcuate track 17 with a “T” shaped cross section, and a pivot shaft 18. The plate 16 can be secured to the dock wall 2 with conventional anchor bolts 19. A bag support plate 20 projects outward from the plate 16 and carries an inflatable bag assembly 21 attached at one end by clamp bar 22 and bolts 23. The bag assembly 21 may be constructed with multiple interconnected chambers to provide the desired shape when inflated. The bag assembly 21 is connected to a source of low pressure air such as the blower 24. The blower 24 may be mounted on the frame assembly 15 or may be mounted remote from the vehicle restraint 10 and connected to the bag assembly 21 by a suitable duct.

The vehicle restraint 10 has a restraining arm assembly 30 having a hub 31 that pivots about the shaft 18 on the frame assembly 15. An arm 32 connects the hub 31 to a guide block 33 that has a “C” shaped opening to engage the arcuate track 17 on the frame assembly 15. The arm 22 also carries a pressure plate 36. A tubular arm 34 projects horizontally outward from the guide block 33 and carries a vertical flange 35 that engages the RIG 37 (rear impact guard, also known as the ICC bar) of a transport vehicle.

The restraining arm assembly 30 is normally in the lower stored position as shown in FIG. 1. When the transport vehicle has been parked at the dock, the blower 24 can be energized to inflate the bag assembly 21. Air pressure within the bag assembly bears against the pressure plate 36 on the restraining arm assembly 30 and lifts it until the horizontal tube 34 engages the underside of the RIG 37 and the vertical flange 35 will prevent outward movement of the RIG 37 from the loading dock. The inflated air bag assembly 21 is resilient and will bias the restraining arm assembly 30 to rotate upward and maintain contact with the RIG 37 to follow the vertical motion of the vehicle suspension. Thus the flange 35 will remain in front of the RIG 37 and prevent the transport vehicle from moving away from the loading dock. The inflated air bag assembly 21 performs the functions of both the actuating means and the spring biasing means of prior art vehicle restraints. The vehicle restraint 10 may be fitted with limit switches or other sensors (not shown) to control signal lights and sense if the restraint is stored or engaged

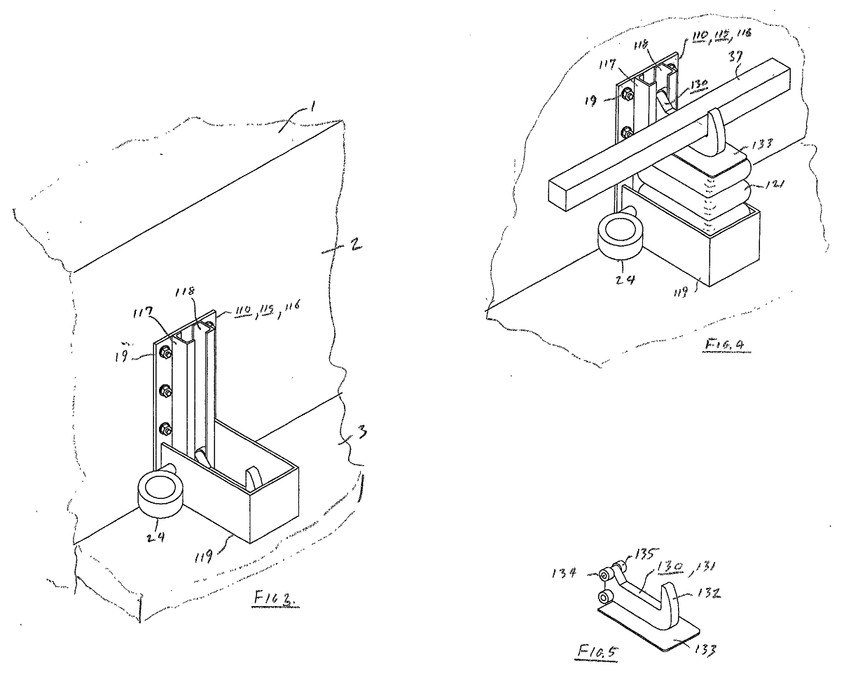

Referring now to FIGS. 3 and 4 a second preferred embodiment is illustrated. A loading dock has a dock floor 1, a dock wall 2 and a driveway 3. A vehicle restraint 110 is mounted on the dock wall 2. The vehicle restraint has a supporting frame assembly 115 composed of a plate 116, two “C” shaped track members 117 and 118, and a protective housing 119. The plate 116 can be secured to the dock wall 2 with conventional anchor bolts 19. As shown in FIG. 5 a restraining hook assembly 130 has a horizontal shank 131 and a vertical restraining member 132. A pressure plate 133 is attached to the bottom of the shank. The rear portion of the shank 131 has two shafts 134 that carry four rollers 135. The rollers fit within the opening of the track members 117 and 118 of the frame assembly 115 and allow the hook assembly 130 to move vertically. An inflatable bag assembly 121 rests on the bottom of the housing 119 and is connected to a source of low pressure air such as the blower 24. The bag assembly 121 may be constructed with multiple interconnected chambers to provide the desired shape when inflated. The blower 24 may be mounted on the frame assembly 15 or may be mounted remote from the vehicle restraint 110 and connected to the bag assembly 121 by a suitable duct. As in the first preferred embodiment, air pressure within the bag assembly 121 bears against the plate 133 on the restraining hook assembly 130 and lifts it until the top of the shank 131 engages the underside of the RIG 37. The vertical restraining member 132 will remain in front of the RIG 37 and prevent outward movement of the transport vehicle from the loading dock.

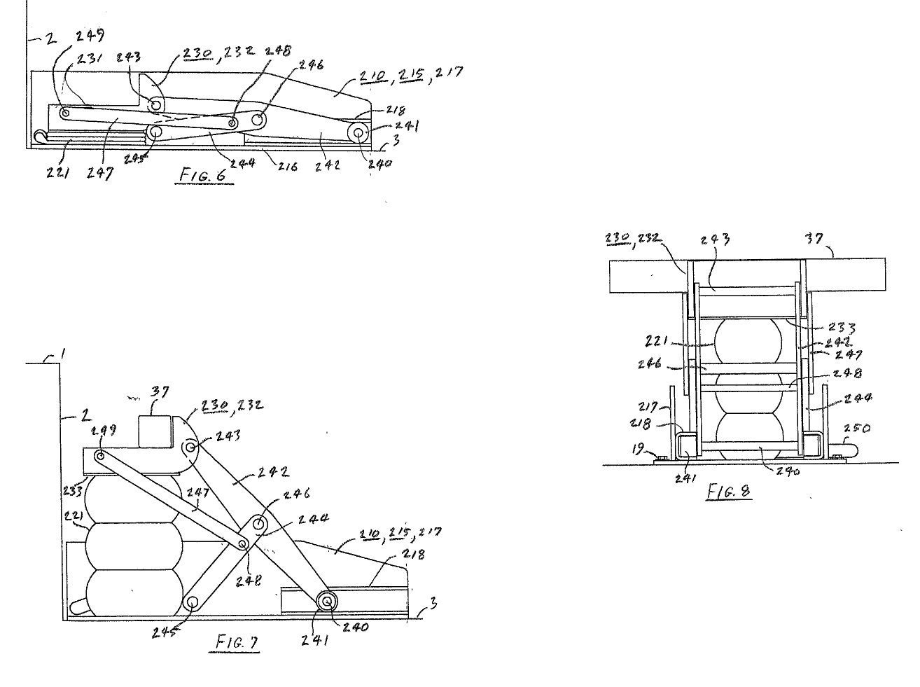

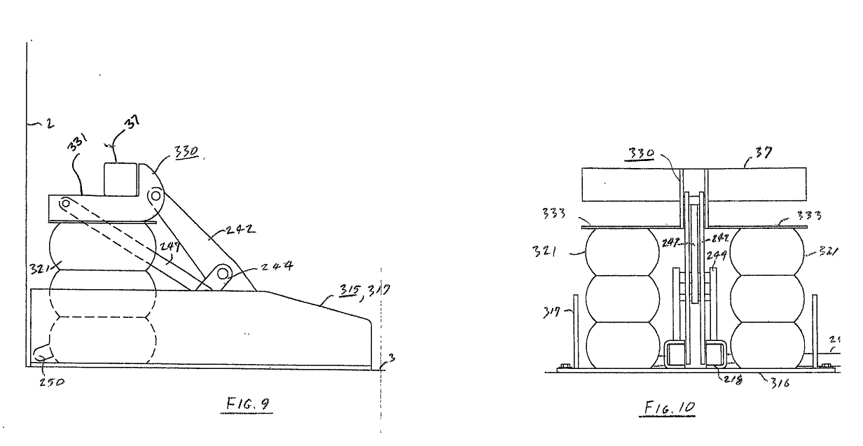

Referring now to FIGS. 6 and 7 a third preferred embodiment is illustrated. A loading dock has a dock floor 1, a dock wall 2 and a driveway 3. A vehicle restraint 210 is mounted on the driveway 3. As shown in the sectional view FIG. 6, the vehicle restraint has a supporting frame assembly 215 composed of a base plate 216, two side plates 217 and two “C” shaped track members 218. As shown in FIG. 8, the plate 216 can be secured to the driveway 3 with conventional anchor bolts 19. A restraining hook 230 has a horizontal shank 231 and a vertical restraining member 232. A pressure plate 233 is attached to the bottom of the shank. The restraining hook assembly 230 is carried by a mechanical linkage consisting of three pairs of pivoting arms connected by pins. A shaft 240 carries two rollers 241 and two main arms 242. The rollers are guided by the two “C” shaped track members 218. The upper ends of the main arms are connected to the restraining hook 230 by the pin 243. The front arms 244 are carried by a pin 245 mounted on the side plates 217. The upper ends of the arms 244 are attached to the main arms 242 by the pin 246. The upper arms 247 are mounted at one end to the front arms 244 by the pin 248 and at the other end to the restraining hook 230 by the pin 249. The proportions of the pivoting links are chosen to guide the hook assembly 230 along a vertical path while preventing horizontal movement. An inflatable bag assembly 221 rests on the base plate 216 and is connected by the duct 250 to a source of low pressure air such as a blower (not shown). The bag assembly may be constructed with multiple interconnected chambers to provide the desired shape when inflated.

An air pressure within the bag assembly 221 bears against the pressure plate 233 on the restraining hook assembly 230 and lifts it until the top of the shank 231 engages the underside of the RIG 37. The vertical restraining member 232 will remain in front of the RIG 37 and prevent outward movement of the transport vehicle from the loading dock.

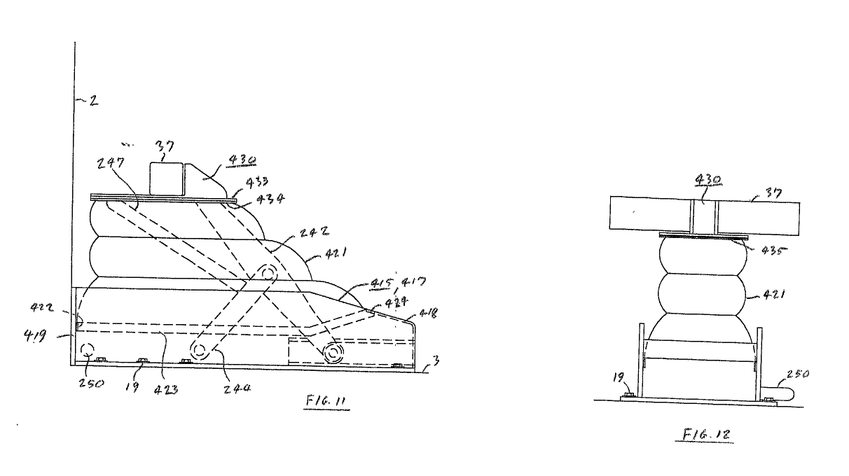

Referring now to FIGS. 9 and 10 a fourth preferred embodiment is illustrated. A hook member 330 is supported by the three pairs of pivoting arms 242, 244 and 247. The frame assembly 315 has side plates 317 that are set wider apart to provide room for two flexible air bags 321. The hook assembly 330 carries a pressure plate 333 on each side of the shank member 331. The operation of the vehicle restraint is similar to the operation of the third preferred embodiment. However, this configuration allows for a more compact mechanical linkage and a narrower hook member 330 to engage the RIG 37.

Referring now to FIGS. 11 and 12 a fifth preferred embodiment is illustrated. A hook member 430 is supported by the three pairs of pivoting arms 242, 244 and 247. The frame assembly 415 has side plates 417, a front plate 418 and a rear plate 419. The bottom edges of the air bag assembly 421 are fastened to the four sides of the frame assembly 415 by clamp bars 422, 423 and 424. The top edges of the airbag assembly 421 are fastened to the pressure plate 433 by clamp bars 434 and 435. Thus the entire mechanism is sealed within the airbag assembly 421. This configuration provides a more compact vehicle restraint and also seals the mechanism from dirt and debris.

The above description and drawings are only illustrative of preferred embodiments which achieve the objects, features, and advantages of the present invention, and it is not intended that the present invention be limited thereto. Any modification of the present invention which comes within the spirit and scope of the following claims is considered to be part of the present invention.

What is claimed is:

1. A vehicle restraint system, comprising:
a support frame including a support plate, having an arcuate track and a pivot shaft mounted thereon;
a bag support connected to said support plate that projects outwardly from a plane containing said support plate;
a restraining arm assembly which pivots about said pivot shaft and moves along said arcuate track;
a pressure plate; and
an inflatable bag connected between said bag support and said pressure plate, and connected to an air source which inflates and raises said inflatable bag from a stored position to a lifting position.

2. The vehicle restraint system of claim 1, wherein said arcuate track has a T-shaped cross section.

3. The vehicle restraint system of claim 1, wherein said inflatable bag is connected to said bag support by a clamp bar and bolts.

4. The vehicle restraint system of claim 1, wherein said restraining arm assembly further comprises:
a hub that pivots about said pivot shaft;
an elongated arm which connects said hub to a guide block; and
a tubular arm which projects horizontally from said guide block and carries a vertical flange,
wherein said guide block movably engages said arcuate track.

5. The vehicle restraint system of claim 1, wherein said guide block has a C-shaped cross section.

6. The vehicle restraint system of claim 1, wherein said inflatable bag has multiple interconnected chambers.

7. A vehicle restraint system, comprising:
a frame assembly including a support plate, two track members, and a protective housing;
an inflatable bag mounted within said protective housing;
a restraining hook assembly including a horizontal shank and a vertically movable restraining member; and
a pressure plate attached to said horizontal shank,
wherein, said inflatable bag bears against said pressure plate and is connectable to an air source which inflates and raises said inflatable bag from a stored position to a lifting position elevating said pressure plate and said restraining member in a vertical direction along said track members.

8. The vehicle restraint system of claim 7, wherein said two track members are each C-shaped.

9. The vehicle restraint system of claim 7, wherein said restraining member further comprises:
a front portion and a rear portion,
wherein said rear portion has two roller shafts having a pair of rollers mounted on each shaft.

10. The vehicle restraint system of claim 7, wherein said inflatable bag has multiple interconnected chambers.

11. The vehicle restraint system of claim 9, wherein said rollers fit within said track members to allow vertical movement.

12. A method of vehicle restraining comprising the steps of:
storing a vehicle restraint in an inactive position;
elevating said vehicle restraint in a controlled substantially vertical motion;
engaging a vehicle with a restraining device; and
stabilizing said restraining device,
wherein said elevating step uses an inflatable air bag for lift.

13. The method of claim 12, wherein said inflatable air bag has multiple interconnected chambers.

14. The method of claim 12, wherein said step of elevating said vehicle restraint in a controlled motion comprises a guide frame.

15. The method of claim 14, wherein said guide frame further comprises:
a base plate connected to two side plates having two track members attached thereto.

16. The method of claim 15, wherein said stabilizing step comprises a plurality of pivot arms linked to said guide frame and said restraining device.

17. The method of claim 16, wherein said track members have rollers connected to said pivot arms mounted therein.

18. The method of claim 12, wherein said restraining device is a hook member.

19. A vehicle restraint system comprising:
means for storing a vehicle restraint in an inactive position;
means for stabilizing said vehicle restraint;
means for elevating said vehicle restraint in a controlled substantially vertical motion; and
means for engaging a vehicle.

20. The vehicle restraint system of claim 19, wherein said means for engaging is a restraining device.

21. The vehicle restraint system of claim 19, wherein said means for storing is a protective housing.

22. The vehicle restraint system of claim 19, wherein said means for elevating is an inflatable air bag connected to an air source.

23. The vehicle restraint system of claim 19, wherein said means for stabilizing said vehicle restraint comprises a plurality of pivot arms linked to a frame assembly.

24. The vehicle restraint system of claim 22, wherein said inflatable air bag envelopes said plurality of pivot arms.

25. The vehicle restraint system of claim 23, wherein said frame assembly further comprises:
two side plates connected to a front plate and a rear plate, and
wherein the bottom of the inflatable air bag is fastened to said plates.
